(19) United States
(12) Patent Application Publication
(10) Pub. No.: US 2003/0068603 A1
(43) Pub. Date: Apr. 10, 2003

(54) Systematic method for creating reading materials targeted to specific readability levels

(76) Inventor: Cindy Cupp, Savannah, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 10/245,068

(22) Filed: Sep. 17, 2002

Related U.S. Application Data
(60) Provisional application No. 60/322,812, filed on Sep. 17, 2001.

(51) Int. Cl. G09B 17/00

(52) U.S. Cl. 434/178

(57) ABSTRACT

In conjunction with authoring a written work, determining a target readability level, a target percentage of sight words, and a target phonic skill level of the work. The written work is edited until the readability level of the work is equal to the target readability level, the percentage of sight words in the work is equal to the target percentage of sight words, and the phonic skill level of the work is equal to the target phonic skill level.

### CROSS REFERENCE TO RELATED APPLICATIONS

This patent application claims priority under Title 35, United States Code Section 119(e) to U.S. Provisional Patent Application No. 60/322,812 entitled “Systematic Method for Creating Reading Materials Targeted to Specific readability Levels” filed on Sep. 17, 2001.

### FIELD OF THE INVENTION

The present invention relates generally to reading programs for teaching students to read and write. More particularly, the present invention relates to systematic method for creating reading materials targeted to specific readability levels.

### BACKGROUND OF THE INVENTION

Reading programs have been used to teach students to read since the early 1900's. These reading programs historically have either used a basic sight word approach (e.g., as in the well-known Sally, Dick and Jane Readers) or a phonics approach. In a sight words approach, students are introduced to a small number of basic sight words in each book or story included in the reading program. The basic sight words build on each other as the student moves through a series of books. There are approximately 220 basic sight words introduced in beginning reading programs. In a phonics approach, students are taught to “sound out” unrecognized words. However, there remains a need for reading programs that combine the sight words approach and the phonics approach.

Some reading materials are assigned a readability level. There are a number of well-known algorithms for determining the readability level of a written work. For example, the Flesch-Kincaide readability test is designed to score a written work based on the year and month of school in which the average student would be able to read the work. For example, a readability level of 1.8 corresponds to a reading level of: first grade, eighth month.

Determining the readability level of a written work is generally an after-though. In other words, the author does not sit down to write a story having a particular readability level. However, after the work is completed and the readability level is determined, the work may be directed to students having the appropriate reading skill level. Thus, there remains a need for a method of writing a reading program comprising a series of written works, each written to a precise readability level.

### BRIEF DESCRIPTION OF THE DRAWINGS

FIG. 1 is a flow chart illustrating an exemplary method for creating a written work having a selected target readability level, a selected target percentage of sight words and a selected target phonic skill level in accordance with an illustrative embodiment of the present invention.

FIG. 2 is a flow chart illustrating an exemplary method for editing a written work to increase its readability level in accordance with an illustrative embodiment of the present invention.

FIG. 3 is a flow chart illustrating an exemplary method for editing a written work to decrease its readability level in accordance with an illustrative embodiment of the present invention.

FIG. 4 is a block diagram of a personal computer system, illustrating an exemplary operating environment for implementation of an illustrative embodiment of the present invention.

### DETAILED DESCRIPTION OF EXEMPLARY EMBODIMENTS

The present invention is directed to systems and methods for creating reading materials written to target readability levels and including target percentages of sight words and/or target phonic skill levels. As used herein, the term “target” is meant to indicate a number (e.g., readability level, percentage of sight words or phonic skill level) that is selected before the reading material is authored. For example, it may be decided that a first grade reading program is needed having a target percentage of sight words equal to 95%. It may also be decided that the first grade reading program will be based on the Flesch-Kincaide scale and will include reading materials having target readability levels ranging from 1.1 to 1.9, inclusive. It may further be decided that the first grade reading material should be written to a phonic skill level that includes only certain short vowel sounds. Under this scenario, the present invention will allow the author to create the desired reading materials having precise readability levels and a precise percentage of sight words. The percentage of each reading material that is not written using the sight word approach is written using the phonics approach and may be written to a precise phonic skill level. Those skilled in the art will recognize that any readability scale may be used and that reading programs may be written for any grade level in accordance with the present invention.

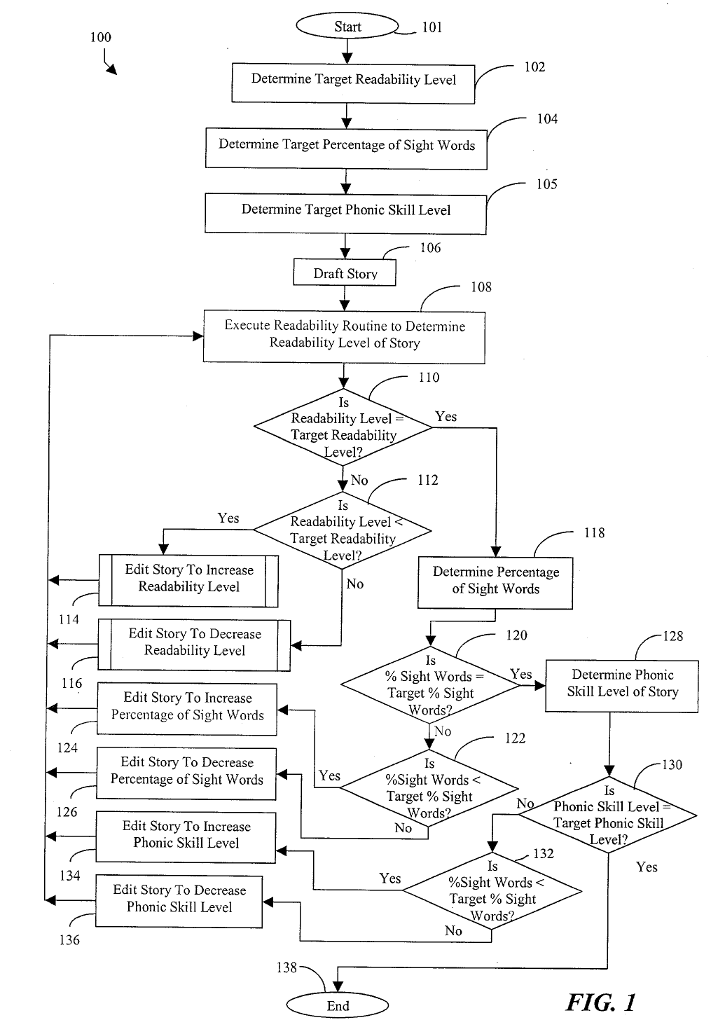

The following description will hereinafter refer to the drawings, in which like numerals indicate like elements throughout the several figures. FIG. 1 is a flow chart illustrating an exemplary method for writing a written work having a selected target readability level and a selected target percentage of sight words in accordance with an illustrative embodiment of the present invention. The method 100 begins at starting block 101 and advances to step 102, where the target readability level is determined. The target readability level may be determined by the author, publisher, educator, or any other person. The readability level may be based on any well-known or custom-designed readability scale. Exemplary embodiments of the present invention will be described with reference to the Flesch-Kincaide readability scale but are not intended to be limited thereto.

After the target readability level is determined, the method progresses to step 104, where the target percentage of sight words is determined. Again, the target percentage of sight words may be determined by the author, publisher, educator, or any other person. At step 105, the target phonic skill level is determined. The target phonic skill level scale may also be determined by the author, publisher, educator, or any other person. Each phonic skill level may be defined, for example, to include certain phonetic sounds. Next at step 106, the author drafts the written material (e.g., a story). The story may be drafted using any processor-driven device (e.g., a personal computer) that executes a word processing program module.

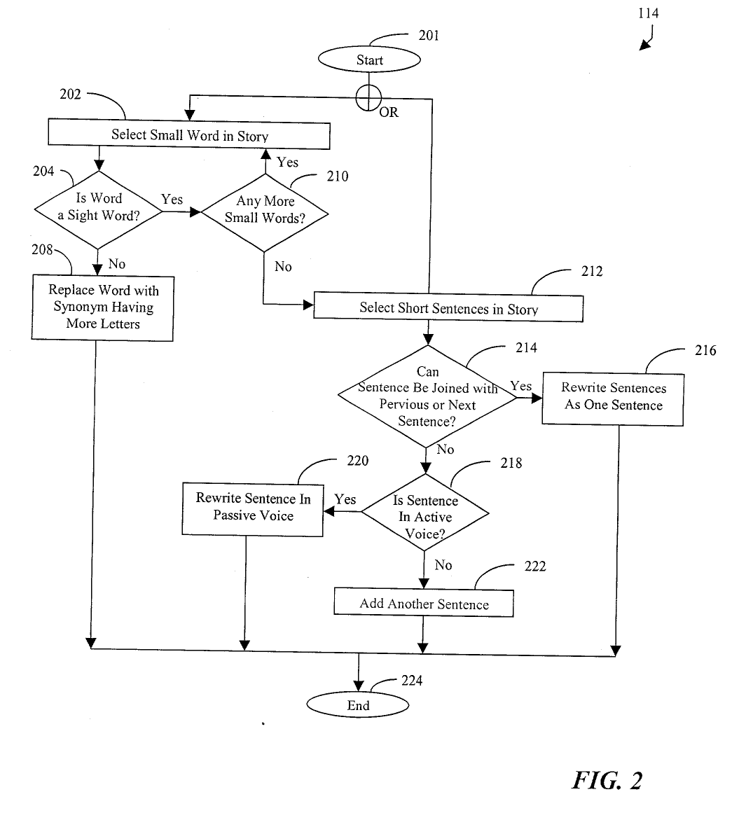

At step 108, a readability routine is executed to determine the readability level of the story. The first draft of the story is preferably completed at this point, but the readability routine may also be executed on an incomplete draft. The readability routine may be configured as a feature of the word processing module describe above. At step 110 the readability level of the story as determined by the readability routine is compared to the target readability level to determine if the two are equal. If the readability level of the story and the target readability level are not equal, the method progresses to step 112, where it is determined if the readability level of the story is less than the target readability level. If the readability level of the story is less than the target readability level, the story is edited to increase its readability level at step 114. As will be appreciated, there are many possible techniques for editing a story to increase its readability level. By way of example only, the readability level of the story may be increased by replacing smaller words with larger words, sight words with phonetic words, shorter sentences with longer sentences, etc. An exemplary method for editing a story to increase its readability level is described below with respect to FIG. 2

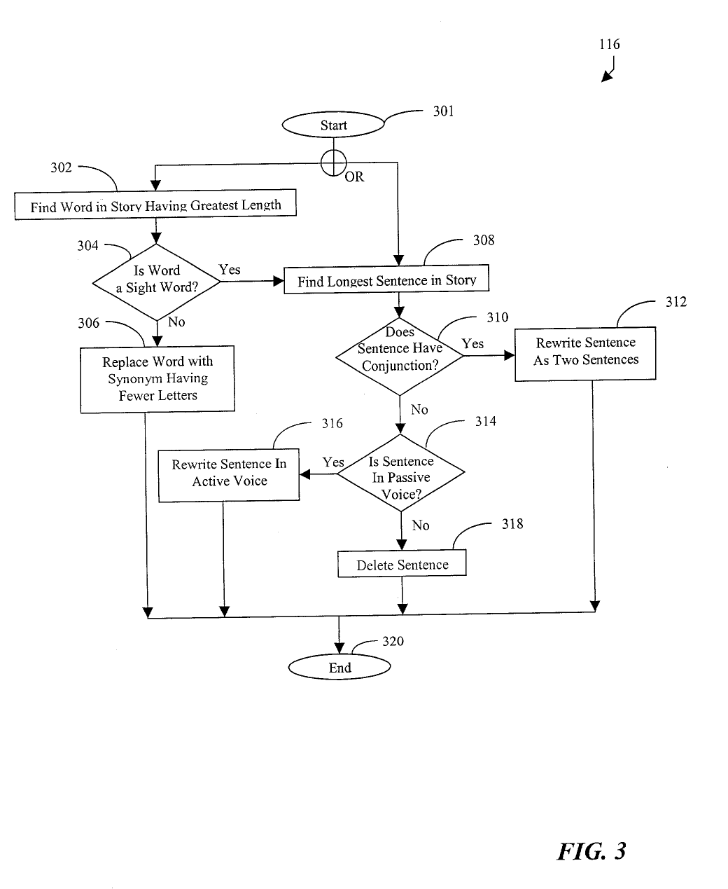

If at step 112 it is determined that the readability level of the story is not less than the target readability level, the method progresses to step 116, where the story is edited to decrease its readability. As will be appreciated, there are many possible techniques for editing a story to decrease its readability level. By way of example only, the readability level of the story may be decreased by replacing larger words with smaller words, phonetic words with sight words, longer sentences with shorter sentences, etc. An exemplary method for editing a story to decrease its readability level is described below with respect to FIG. 3.

After the story is edited at step 114 or step 116, the method returns to step 108 for re-execution of the readability routine. As described above, the readability level of the story, as edited, is compared to the target readability level at step 110 to see if the two are equal. If the readability level of the story is still not equal to the target readability level, the method moves to step 112 to determine if the readability level of the story is greater or less than the target readability level. The story is then edited at step 114 or step 116, as appropriate, and the method once again returns to step 108 for re-execution of the readability routine. The loop between steps 108 and 116 is repeated until it is determined at step 110 that the readability level of the story is equal to the target readability level.

When the readability level of the story is determined at step 110 to be equal to the target readability level, the method advances to step 118 to determine the percentage of sight words in the story. In an exemplary embodiment of the present invention, the word processing program module may be configured to highlight (e.g., underline, color, bold, etc.) any sight words as they are written by the author. Optionally the word processing program module may be configured to keep a running count of the percentage of sight words as the author types the story. In this way, the author will have a good idea as to whether the story is being written to include the target percentage of sight words. For example, a database or list of all sight words may be stored in a memory of the processor-driven device and may be accessed automatically or in response to a user input command in order to determine the words in the story that are sight words.

Whether based on a running count or percentage of sight words or on the skill of the author, the first draft of the story may have a percentage of sight words that is approximately equal to the target percentage of sight words. However, the percentage of sight words in the story may be altered during the editing processes of steps 114 and 116. Thus, after determining the percentage of sight words at step 118, the method advances to step 120 to determine whether the percentage of sight words in the story is equal to the target percentage of sight words.

If the percentage of sight words in the story is not equal to the target percentage of sight words, the method progresses to step 122, where it is determined whether the percentage of sight words in the story is less than the target percentage of sight words.

If the percentage of sight words in the story is less than the target percentage of sight words, the story is edited at step 124 to increase the percentage of sight words. Those skilled in the art will appreciate that the percentage of sight words in the story may be increased by replacing non-sight words with sight words, or by adding additional sight words to the text. If the percentage of sight words in the story is not less than the target percentage of sight words, the story is edited at step 126 to decrease the percentage of sight words. Those skilled in the art will appreciate that the percentage of sight words in the story may be decreased by replacing sight words with non-sight words, or by deleting sight words from the text.

After the story is edited at step 124 or step 126, the method returns to step 108 for re-execution of the readability routine. From step 108 the method is repeated, as described above, to ensure that the readability level of the story is equal to the target readability level and that the percentage of sight words in the story is equal to the target percentage of sight words.

When it is determined at step 120 that the percentage of sight words in the story is determined to be equal to the target percentage of sight words, the method advances to step 128, where the phonics skill level of the story is determined. As an example, a program module may be configured to analyze each word (or at least each non-sight word) in the story to determine a list of phonetics used in the story. The list of phonetics used may be compared to a data file or the like storing information regarding a phonic skill level scale in order to determine the phonic skill level of the story. Other method for determining the phonic skill level of a story will be recognized by those of ordinary skill in the art and are therefore contemplated by the present invention.

From step 128, the method proceeds to step 130 to determine whether the phonic skill level of the story is equal to the target phonic skill level. If the phonic skill level of the story is not equal to the target phonic skill level, the method progresses to step 132, where it is determined whether the phonic skill level of the story is less than the target phonic skill level. If the phonic skill level of the story is less than the target phonic skill level, the story is edited at step 134 to increase its phonic skill level. Those skilled in the art will appreciate that the phonic skill level may be increased by replacing shorter words with synonyms having more syllables, or by adding additional and more phonetically complex words to the text. Other methods for increasing the phonic skill level will be evident. If the phonic skill level of the story is not less than the target phonic skill level, the story is edited at step 136 to decrease its phonic skill level. Those skilled in the art will appreciate that the phonic skill level of the story may be decreased by replacing longer words with words having fewer syllables or by deleting more phonetically complex words from the text. Other methods for decreasing the phonic skill level will be evident.

After the story is edited at step 134 or step 136, the method returns to step 108 for re-execution of the readability routine. From step 108 the method is repeated, as described above, to ensure that the readability level of the story is equal to the target readability level and that the percentage of sight words in the story is equal to the target percentage of sight words. When the readability level of the story is determined to be equal to the target readability level at step 110 and the percentage of sight words in the story is determined to be equal to the target percentage of sight words at step 120 and the phonic skill level of the story is determined to be equal to the target phonic skill level at step 130, the method ends at step 138.

Those skilled in the art will recognize that a determination of whether the readability level of the story is equal to the target readability level or the percentage of sight words in the story is equal to the target percentage of sight words or the phonic skill level of the story is equal to the target phonic skill level may be based on a predetermined acceptable tolerance. For example, the target percentage of sight words may have an acceptable tolerance of +/−0.05% or any other acceptable tolerance. Furthermore, the method described above with respect to FIG. 1 contemplates creating a written work using a target readability level, a target percentage of sight words and a target phonic skill level. Those skilled in the art will appreciate that in certain embodiments of the present invention, a written work may be created wherein use of the target percentage of sight words and/or the target phonic skill level is optional.

FIG. 2 is a flow chart illustrating an exemplary process (e.g., step 114 from FIG. 1) for editing a written work to increase its readability level in accordance with an illustrative embodiment of the present invention. The method 114 begins at starting bock 201 and advances to either step 202 for selection of a small word in the story or to step 212 for selection of two consecutive short sentences. The decision to proceed to either step 202 or step 212 may be made based on a number of factors. For example, a rule may be implemented to dictate that either step 202 or step 212 is always selected. Alternatively, a rule may be implemented based on a running estimate of the percentage of sight words in the story, such that if the estimated percentage of sight words if substantially equal to or greater than the target percentage of sight words, the method proceeds to step 202, otherwise to step 212. As yet another example, the decision to proceed to either step 202 or step 212 may be made based on whether there is a larger deviation between the percentage sight words and the target percentage sight words or between the readability level and the target readability level. Those skilled in the art will appreciate that the decision may also be made randomly or based on any other weighting technique.

At step 202 a small word in the story is selected. The small word may be chosen based on the number of letters in the word, the number of syllables in the word, or any other suitable criteria. Rules may optionally be implemented such that certain small words are ignored (i.e., are not selected), such as the words “I,” “we,” “me” “my,” “on,” “the,” “a,” etc. Next at step 204, a determination is made as to whether the selected word is a sight word. It may be desirable not to edit or delete any sight words, so as not to alter the percentage of sight words in the story to the extent possible. Thus, if the selected word is a sight word, the exemplary method advances to step 210 to determine if there are any other small words in the story to select. If there are other small words in the story to select, the method returns to step 202 for the selection of another small word. When a small word is selected that is determined at step 204 not to be a sight word, the word is replaced at step 208 with a synonym having more letters. After completion of step 208, the method ends at step 224.

However, if it is determined at step 210 that there are no other small words in the story to select, the method proceeds to step 212. As mentioned, the method may have optionally proceeded to step 212 directly from starting block 201. At step 212 a short sentence is selected. Selection of a short sentence may be based on the number of words or syllables in the sentence, the number of verbs in the sentence, the number of conjunctions in the sentence, or any other suitable criteria.

Next at step 214 a determination is made as to whether the selected short sentence can be joined with either the previous or the next sentence. For example, a grammar checker program module may be used to determine if the selected short sentence can be added either the previous or next sentence using a conjunction or other modifier to create a grammatically correct sentence. If the selected short sentence can be added either the previous or next sentence, the appropriate sentences are rewritten as one sentence at step 216. After completion of step 216, the method ends at step 224.

If the selected short sentence cannot be added either the previous or next sentence, the method advances from step 214 to step 218, to determine whether the selected short sentence is written in the active voice. If the selected short sentence is written in the active voice, it is rewritten in the passive voice at step 220. After completion of step 220, the method ends at step 224.

If the selected short sentence is not written in the active voice, the method advances from step 218 to step 222, where another sentence is added to the story. After completion of step 222, the method ends at step 224.

Those skilled in the art will recognize that the method steps described above with respect to method 114 of FIG. 2 are provided by way of example only and are not intended to limit the scope of the present invention. Other methods and method steps may be performed for increasing the readability level of a written work in accordance with the present invention.

The method steps described above with respect to FIG. 2 are intended to be by way of example only and are not intended to limit the scope of the present invention. Other methods and/or method steps may be performed for increasing the readability level of a written work in accordance with the present invention.

FIG. 3 is a flow chart illustrating an exemplary process (e.g., step 116 from FIG. 1) for editing a written work to decrease its readability level in accordance with an illustrative embodiment of the present invention. The method 116 begins at starting bock 301 and advances to either step 302 for selection of the word in the story having the greatest length or to step 308 for selection of the longest sentence in the story. The decision to proceed to either step 302 or step 308 may be made based on a number of factors. For example, a rule may be implemented to dictate that either of step 302 or step 308 is always selected. Alternatively, a rule may be implemented based on a running estimate of the percentage of sight words in the story, such that if the estimated percentage of sight words if substantially equal to or greater than the target percentage of sight words, the method proceeds to step 302, otherwise to step 308. As yet another example, the decision to proceed to either step 302 or step 308 may be made based on whether there is a larger deviation between the percentage sight words and the target percentage sight words or between the readability level and the target readability level. Those skilled in the art will appreciate that the decision may also be made randomly or based on any other weighting technique.

At step 302 the longest word in the story is selected. The word is preferably chosen based on the number of letters in the word. Next at step 304, a determination is made as to whether the selected word is a sight word. It may be desirable not to edit or delete any sight words, so as not to alter the percentage of sight words in the story to the extent possible. Thus, if the selected word is a sight word, the exemplary method advances to step 308 for selection of the longest sentence. Otherwise, the method proceeds to step 306 where the selected word is replaced with a synonym having fewer letters. After completion of step 306, the method ends at step 320.

At step 308, the longest sentence is selected. Selection of the longest sentence may be based on the number of words or syllables in the sentence, the number of verbs in the sentence, the number of conjunctions in the sentence, or any other suitable criteria. Next at step 310 a determination is made as to whether the selected sentence includes a conjunction (or other suitable language) that would allow it to be broken into two shorter sentences. If the selected sentence can be broken into two shorter sentences, such action is taken at step 312. After completion of step 312, the method ends at step 320.

If the selected sentence cannot be broken into two shorter sentences, the method advances from step 310 to step 314, to determine whether the selected sentence is written in the passive voice. If the selected short sentence is written in the passive voice, it is rewritten in the active voice at step 316. After completion of step 316, the method ends at step 320.

If the selected sentence is not written in the passive voice, the method advances from step 314 to step 318, where it is deleted. If a sentence is deleted, the author may optionally be prompted or otherwise choose to add a replacement sentence in an attempt to maintain the flow of the story, if necessary. After completion of step 318, the method ends at step 320.

The method steps described above with respect to FIG. 3 are intended to be by way of example only and are not intended to limit the scope of the present invention. Other methods and/or method steps may be performed for decreasing the readability level of a written work in accordance with the present invention.

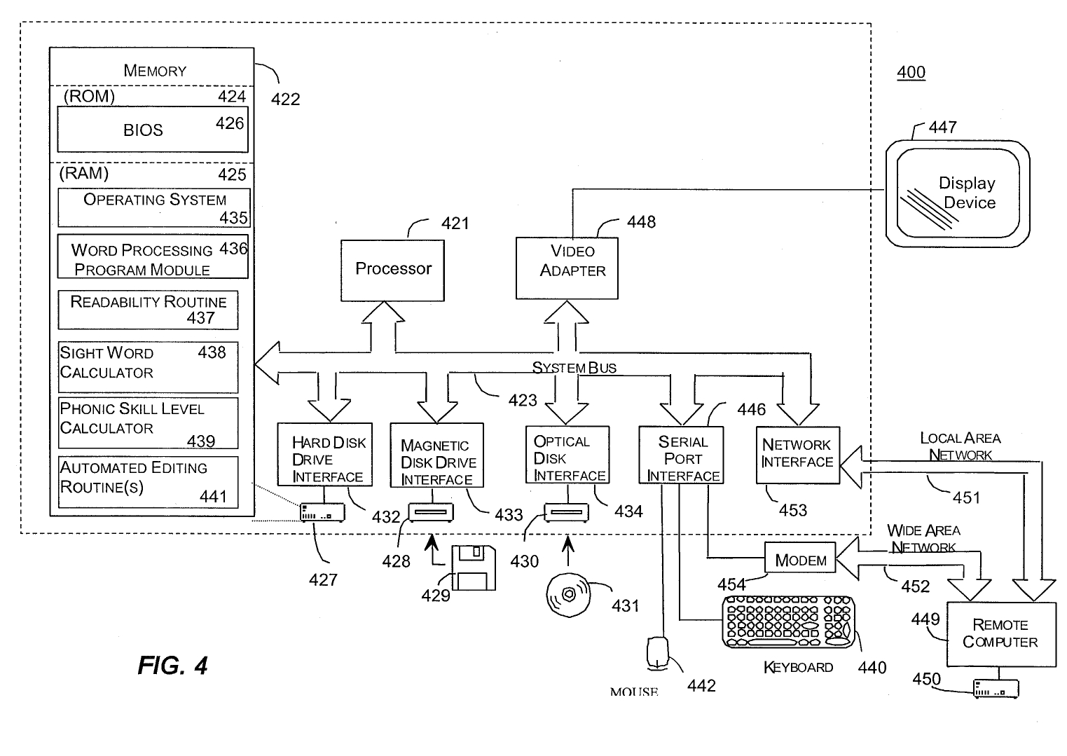

In addition, those skilled in the art will appreciate that many or all of the exemplary method steps described with respect to FIGS. 1-3 may be embodied as computer-executable instructions to be executed by any processor-driven device, such as a personal computer. As previously mentioned, such computer-executable instructions may be embodied as features included in a word processing program module. Accordingly, FIG. 4 and the following discussion are intended to provide a brief and general description of a suitable computing environment for implementing the present invention. Although the system shown in FIG. 4 represents a conventional personal computer system 400, those skilled in the art will recognize that the invention also may be implemented using other types of computer system configurations.

The exemplary computer system 400 includes a processor 421, a system memory 422 and a system bus 423 that couples the system memory 422 to the processor 421. The system memory 422 includes read only memory (ROM) 424 and random access memory (RAM) 425. A basic input/output system 426 (BIOS), containing basic routines that help to transfer information between elements within the personal computer system 400, such as during start-up, is stored in ROM 424.

The personal computer system 400 further includes a hard disk drive 427, a magnetic disk drive 428, e.g., to read from or write to a removable disk 429, and an optical disk drive 430, e.g., for reading a CD-ROM disk 431 or to read from or write to other optical media. The hard disk drive 427, magnetic disk drive 428, and optical disk drive 430 are connected to the system bus 423 by a hard disk drive interface 432, a magnetic disk drive interface 433, and an optical drive interface 434, respectively. The drives and their associated computer-readable media provide nonvolatile storage (e.g., memory) for the personal computer system 400. Although the description of computer-readable media above refers to a hard disk, a removable magnetic disk and a CD-ROM disk, it should be appreciated by those skilled in the art that other types of media that are readable by a computer system, such as magnetic cassettes, flash memory cards, digital video disks, Bernoulli cartridges, and the like, may also be used in the exemplary operating environment.

A number of program modules may be stored in the persistent storage devices (e.g., hard disk drive 427) and the memory 422 (e.g., RAM 425), including an operating system 435 and a word processing program module 436. The various methods of the present invention may also be implemented as program modules, referred to herein as a Readability Routine 437, a Sight Word Calculator 438, a Phonic Skill Level Calculator 439 and one or more Automated Editing Routines 441.

Other input devices (not shown) may include a microphone, joystick, game pad, satellite dish, scanner, or the like. These and other input devices are often connected to the processor 421 through a serial port interface 446 that is coupled to the system bus 423, but may be connected by other interfaces, such as a game port or a universal serial bus (USB). A display device 447 is also connected to the system bus 423 via an interface, such as a video adapter 448. In addition to display device, personal computer systems typically include other peripheral output devices (not shown), such as speakers or printers.

The personal computer system 400 may operate in a networked environment using logical connections to one or more remote computer systems, such as a remote computer system 449. The remote computer system 449 may be a server, a router, a peer device or other common network node, and typically includes many or all of the elements described above relative to the personal computer system 400, although only a storage device 450 has been illustrated in FIG. 4. The logical connections depicted in FIG. 4 include a local area network (LAN) 451 and a wide area network (WAN) 452. Such networking environments are commonplace in offices, enterprise-wide computer networks, intranets and the Internet.

When used in a LAN networking environment, the personal computer system 400 is connected to the LAN 451 through a network interface 453. When used in a WAN networking environment, the personal computer system 400 typically includes a modem 454 or other means for establishing communications over the WAN 452, such as the Internet. The modem 454, which may be internal or external, is connected to the system bus 423 via the serial port interface 446. In a networked environment, program modules depicted relative to the personal computer system 400, or portions thereof, may be stored in the remote memory storage device. It will be appreciated that the network connections shown are exemplary and other means of establishing a communications link between the computer systems may be used. It will be further appreciated that the invention could equivalently be implemented on host or server computer systems other than personal computer systems, and could equivalently be transmitted to the host computer system by means other than a CD-ROM, for example, by way of the network connection interface 453.

As may be seen from the foregoing, the present invention provides systems and methods for systematically creating reading materials written to selected target readability levels and having target percentages of sight words and/or target phonic skill levels. The present invention is particularly useful to educators who desire to author precisely controlled reading programs for their students. In addition, the present invention is useful to students who desire to improve their writing skills. For example, a student may employ the present invention to determine the readability level, percentage of sight words and/or phonic skill level of a work. The automated editing routines contemplated by the present invention may be configured to display any suggested revisions that may be used to increase the readability level, percentage of sight words and/or target phonic skill level of the work, thereby teaching the student to improve his/her writing skill level.

Those skilled in the art will appreciate that the foregoing description of the invention was provided by way of example only and that many other modifications, features, embodiments and operating environments of the present invention are possible. By way of example only, the present invention may also be implemented in a networked environment wherein the author drafts a reading program a one network device and transmits it to a second network device to be edited to the target readability level and target percentage of sight words. Still other alternate embodiments will become apparent to those of ordinary skill in the art. It should further be appreciated that the exemplary aspects of the present invention as described above are not intended to be interpreted as required or essential elements of the invention, unless explicitly stated otherwise.

The invention claim is:

1. A method for creating reading materials having a target readability level, a target percentage of sight words, and a target phonic skill level comprising:
in advance of authoring a written work, determining the target readability level, the target percentage of sight words and the target phonic skill level of the work;
after determining the target readability level, the target percentage of sight words and the target phonic skill level, authoring the work; and
after authoring the work, repeating the following steps until it is determined that (1) a readability level of the work is equal to the target readability level and (2) a percentage of sight words in the work is equal to the target percentage of sight words and (3) a phonic skill level of the work is equal to the target phonic skill level:
determining the readability level of the work,
if the readability of the work is less than the target readability level, editing the work to increase the readability level,
if the readability of the work is greater than the target readability level, editing the work to decrease the readability level,
if the readability of the work is equal to the target readability level, determining the percentage of sight words included in the work,
if the percentage of sight words is less than the target percentage of sight words, editing the work to increase the percentage of sight words,
if the percentage of sight words is greater than the target percentage of sight words, editing the work to decrease the percentage of sight words,
if the percentage of sight words is equal to the target percentage of sight words, determining the phonic skill level of the work,
if the phonic skill level is less than the target phonic skill level, editing the work to increase the phonic skill level, and
if the phonic skill level is greater than the target phonic skill level, editing the work to decrease the phonic skill level.

2. The method of claim 1, wherein the step of editing the work to increase the readability level comprises:
replacing smaller words with larger words;
replacing sight words with phonetic words;
replacing sentences written in active voice with sentences written in passive voice; or
replacing shorter sentences with longer sentences.

3. The method of claim 1, wherein the step of editing the work to decrease the readability level comprises:
replacing larger words with smaller words;
replacing phonetic words with sight words;
replacing sentences written in passive voice with sentences written in active voice; or
replacing longer sentences with shorter sentences.

4. The method of claim 1, wherein the step of editing the work to increase the percentage of sight words comprises:
replacing non-sight words with sight words; or
adding additional sight words to the work.

5. The method of claim 1, wherein the step of editing the work to decrease the percentage of sight words comprises:
replacing sight words with non-sight words; or
adding additional non-sight words to the work.

6. The method of claim 1, wherein the step of editing the work to increase the percentage of phonic words comprises:
replacing shorter words with synonyms having more syllables; or
adding additional phonetically complex words to the work.

7. The method of claim 1, wherein the step of editing the work to decrease the percentage of phonic words comprises:
replacing longer words with synonyms having fewer syllables; or
adding additional phonetically simple words to the work.

8. A method for creating reading materials having a target readability level, a target percentage of sight words, and a target phonic skill level comprising:
authoring a written work;
determining the target readability level, the target percentage of sight words, and the target phonic skill level of the work;
editing the work to change the readability level to the target readability level;
editing the work to change the percentage of sight words to the target percent of sight words; and
editing the work to change the phonic skill level to the target phonic skill level.

9. The method of claim 8, wherein the step of determining the target readability level, the target percentage of sight words, and the target phonic skill level of the work is performed before authoring the work.

10. The method of claim 8, wherein the step of editing the work to change the readability comprises:
if the readability of the work is less than the target readability level, editing the work to increase the readability level; or
if the readability of the work is greater than the target readability level, editing the work to decrease the readability level.

11. The method of claim 8, wherein the step of editing the work to change the percentage of sight words comprises:
if the percentage of sight words is less than the target percentage of sight words, editing the work to increase the percentage of sight words; or
if the percentage of sight words is greater than the target percentage of sight words, editing the work to decrease the percentage of sight words.

12. The method of claim 8, wherein the step of editing the work to change the percentage of sight words comprises:
if the phonic skill level is less than the target phonic skill level, editing the work to increase the phonic skill level; or
if the phonic skill level is greater than the target phonic skill level, editing the work to decrease the phonic skill level.

13. The method of claim 10, wherein the step of editing the work to change the target readability level comprises increasing the target readability level by:
replacing smaller words with larger words;
replacing sight words with phonetic words;
replacing sentences written in active voice with sentences written in passive voice; or
replacing shorter sentences with longer sentences.

14. The method of claim 10, wherein the step of editing the work to change the target readability level comprises decreasing the target readability level by:
replacing larger words with smaller words;
replacing phonetic words with sight words;
replacing sentences written in passive voice with sentences written in active voice; or
replacing longer sentences with shorter sentences.

15. The method of claim 11, wherein the step of editing the work to change the percentage of sight words comprises increasing the percentage of sight words by:
replacing non-sight words with sight words; or
adding additional sight words to the written work.

16. The method of claim 11, wherein the step of editing the work to change the percentage of sight words comprises decreasing the percentage of sight words by:
replacing sight words with non-sight words; or
adding additional non-sight words to the written work.

17. The method of claim 12, wherein the step of editing the work to change the percentage of phonic words comprises increasing the percentage of phonic words by:
replacing shorter words with synonyms having more syllables; or
adding additional phonetically complex words to the written work.

18. The method of claim 12, wherein the step of editing the work to change the percentage of phonic words comprises decreasing the percentage of phonic words by:
replacing longer words with synonyms having fewer syllables; or
adding additional phonetically simple words to the written work.

19. A system for creating reading materials having a target level, a target percentage of sight words, and a target phonic skill level comprising:
a computer system operable to execute a word processor program for authoring a written work;
the computer system operable to execute a readability routine, the readability routine operable to determine a readability level of the written work, said readability routine further operable to edit the written work to change the readability level to the target readability level;
the computer system operable to execute a sight word calculator, the sight word calculator operable to determine a percentage of sight words in the written work, said sight word calculator further operable to edit the written work to change the percentage of sight words to the target percent of sight words; and
the computer system operable to execute a phonic skill calculator, the phonic skill calculator operable to determine a phonic skill level in the written work, said phonic skill calculator further operable to edit the written work to change the phonic skill level to the target phonic skill level.
